(19) United States
(12) Patent Application Publication
(10) Pub. No.: US 2026/0310590 A1
(43) Pub. Date: Oct. 8, 2026

(54) AUTOMATION TESTING

(71) Applicant: Hyland Software, Inc., Westlake, OH (US)

(72) Inventors: Balaji Loganathan, Alpharetta, GA (US); Bobby David, Methuen, MA (US)

(21) Appl. No.: 19/171,643

(22) Filed: Apr. 7, 2025

(51) Int. Cl. G06F 11/3668

(52) U.S. Cl. CPC G06F 11/3688; G06F 11/3692

(57) ABSTRACT

Techniques and systems, described herein, enable an automation testing framework or firmware build system to generate user interface (UI) tests, via the automation testing framework, on different browsers and platforms concurrently. A first set of UI components of a web application can be tested with the UI tests on the different browsers in parallel via a first set of parallel pipelines. A second set of UI components of a mobile application can be tested with the UI tests in parallel via a second set of parallel pipelines. Testing of the first set of UI components of the web application and the second set of UI components of the mobile application can be performed in parallel to one another. The automation testing framework further generates API tests to be performed on the web application and the mobile application in parallel with performing the UI tests.

### FIELD

This disclosure relates to automation testing, and end-to-end testing of product applications across development teams in a single unified automation testing framework.

### BACKGROUND

Project management systems, including application development projects, operate with a high-level user story (e.g., an epic) that can often be too large to be completed in a single project sprint or with a single team. Such development projects therefore divide the high-level user story or epic into smaller, more manageable “user stories” that include functional objectives to be completed among various software development teams of a development cycle and contribute to the high-level objective of the overall epic. The epic or high-level user story operates as a container for multiple related user stories that contribute to a large feature or objective of a product application for deployment to users or clients in client devices. Testing the functionality of all aspects of such product applications associated with the epic is vital to ensuring quality of the user experience and guaranteeing operation according to specifications of the applications, parameters of the epic and user story objectives.

Gaps within the development cycle toward production and deployment make the testing phase of the development cycle unduly complex, time consuming and costly. For example, working on multiple tools for the API, as well as the UI of the subparts or application components of the epic, can require different skill sets every time developers transition from one tool to another. Each tool may include different computer programs with different languages for creating, maintaining, debugging, and supporting associated applications and programs that make up the high-level objectives for the epic. Such tools can be used for smaller programs that focus on specific tasks, functionalities, sub-applications, or application components among the various testing teams contributing to the high level epic story objective. Additionally, shuffling resources from various scripting programs (e.g., Java Script, TypeScript, .Net) can be challenging, adding to the complexity. Further, API testing uses a non-browser automation framework such as Javascript toolchains, .NET, etc., which can also vary between development teams performing user interface (UI) testing. Furthermore, API testing is normally distinct from UI testing application, thereby increasing the developer workload. Therefore, a demand exists for a unified testing framework for automation testing among application development projects.

### BRIEF DESCRIPTION OF THE DRAWINGS

The present disclosure will be readily understood and enabled by the detailed description and accompanying figures of the drawings. Like reference numerals can designate like features and structural elements. Figures and corresponding descriptions are provided as non-limiting examples of aspects, implementations, etc., of the present disclosure, and references to “an” or “one” aspect, implementation, etc., does not necessarily refer to the same aspect, implementation, etc., and can mean at least one, one or more, etc.

FIG. 1 is a diagram of an example overview of an automation testing framework according to one or more implementations (aspects) described herein.

FIG. 2 is a diagram of an example process flow for an automation testing framework according to one or more implementations described herein.

FIG. 3 is an example software set according to one or more implementations described herein.

FIG. 4 is an example consolidated set of resources for an automation testing framework according to one or more implementations described herein.

FIG. 5 is an example automation and execution pipeline of an automation testing framework according to one or more implementations described herein.

FIG. 6 is another example automation and execution pipeline of an automation testing framework according to one or more implementations described herein.

FIG. 7 is a diagram of an example UI testing framework of an automation testing framework according to one or more implementations described herein.

FIG. 8 is a diagram of an example API testing framework of an automation testing framework according to one or more implementations described herein.

FIG. 9 is a diagram of an example of functional elements, components or module of an automation testing framework according to one or more implementations described herein.

FIG. 10 is a diagram of an example continuous integration/continuous integration pipeline of an automation testing framework according to one or more implementations described herein.

FIG. 11 is a diagram of another example continuous integration/continuous integration pipeline of an automation testing framework according to one or more implementations described herein.

FIG. 12 is a diagram of another example process flow for an automation testing framework according to one or more implementations described herein.

FIG. 13 is a diagram of example components of a device that can be used within environments or implementations (aspects) herein.

### DETAILED DESCRIPTION

The following detailed description refers to the accompanying drawings. Like reference numbers in different drawings can identify the same or similar features, elements, operations, etc. Additionally, the present disclosure is not limited to the following description as other implementations can be utilized, and structural or logical changes made, without departing from the scope of the present disclosure.

As utilized in this disclosure, terms “component,” “module”, “system,” “interface,” and the like are intended to refer to a computer-related entity, hardware, software (e.g., in execution), and/or firmware. A component can be referred to as a module, and a module be a component, as used interchangeably herein. For example, a component be a processor (e.g., a microprocessor, a controller, or other processing circuitry or device), a process running on a processor, a controller, an object, an executable, a program, a storage device, a computer, a tablet PC and/or a user equipment (e.g., mobile phone, etc.) with a processing device. By way of illustration, an application running on a server and the server can also be a component. One or more components can reside within a process, and a component can be localized on one computer and/or distributed between two or more computers. The term “circuitry” may refer to, be part of, or include an Application Specific Integrated Circuit (ASIC), an electronic circuit, a processor (shared, dedicated, or group), or associated memory (shared, dedicated, or group) operably coupled to the circuitry that execute one or more software or firmware programs, a combinational logic circuit, or other suitable hardware components that provide the described functionality. In some embodiments, the circuitry may be implemented in, or functions associated with the circuitry may be implemented by, one or more software or firmware modules. In some aspects, circuitry may include logic, at least partially operable in hardware.

In accordance with the demand(s) for a unified testing framework discussed above, various aspects are proposed in this disclosure for an automation testing framework that enables application developer teams to efficiently and effectively operate on different functional aspects of different applications with parallel pipelines for application programming interface (API) testing and user interface (UI) testing, as well as for both web applications and associated mobile applications to be tested at the same time. The automation test framework can be configured to perform UI tests in UI parallel pipelines operating at the same time, or concurrent with, API testing in API parallel pipelines for a web application, a mobile application, or both together as part of the same development build, application, user story, or epic.

In an aspect, the automation testing framework is configured, via processing circuitry, to perform UI interface tests in parallel with API tests for a continuous integration and development pipeline across different browsers and platforms. The automation testing framework can include a set of parallel pipelines performing UI tests in parallel to one another for a web application and another set of parallel pipelines performing UI tests operating in parallel to one another for a mobile application that corresponds to the web application. The automation testing framework is configured to perform these UI tests through the different sets of pipelines concurrent with, or in parallel to, API testing of the web application and the mobile application through API pipelines.

In another aspect, the automation testing framework, via processing circuitry, generates reporting, or a report, that includes results of UI tests for a first set of UI components in the web application and UI tests to a second set of UI components in the mobile application through parallel pipelines. The report is also generated together with a second set of results from API tests being performed on a first set of cloud-based modules of the web application through parallel API pipelines and the API tests to a second set of cloud-based modules of the mobile application through other parallel API pipelines. In this manner, web applications and mobile applications can be de-bugged, updated and maintained alongside one another, maintaining a synchronous operation for a same epic, user story, or application while testing both the API and UI functionality and interactions at a same time.

A framework herein, such as an automation testing framework, can refer to firmware including hardware and software that provides a reusable platform with a foundation for developing software applications in a platform for a user story and a larger epic. A framework can include tools such as libraries, compilers, and support programs for distribution and integration in an application or software build system. The framework can operate to streamline processes to test and develop software applications individually or together for functional operation. A framework can allow software developers to selectively change functionality with user-written code by providing resources in a hardware, software or firmware build system that can be modified for a project's needs or objectives in one or more applications. In particular, the automation testing framework herein can be utilized for working on divisions of epics as user stories or dividing software development tasks into divisions of labor associated with various functionalities of an application type (e.g., a mobile application, a web application, etc.) across multiple platforms (e.g., Google, iOS, etc.), which can be operational together at the same time. Various aspects related to automation testing frameworks are further described herein with reference to the figures.

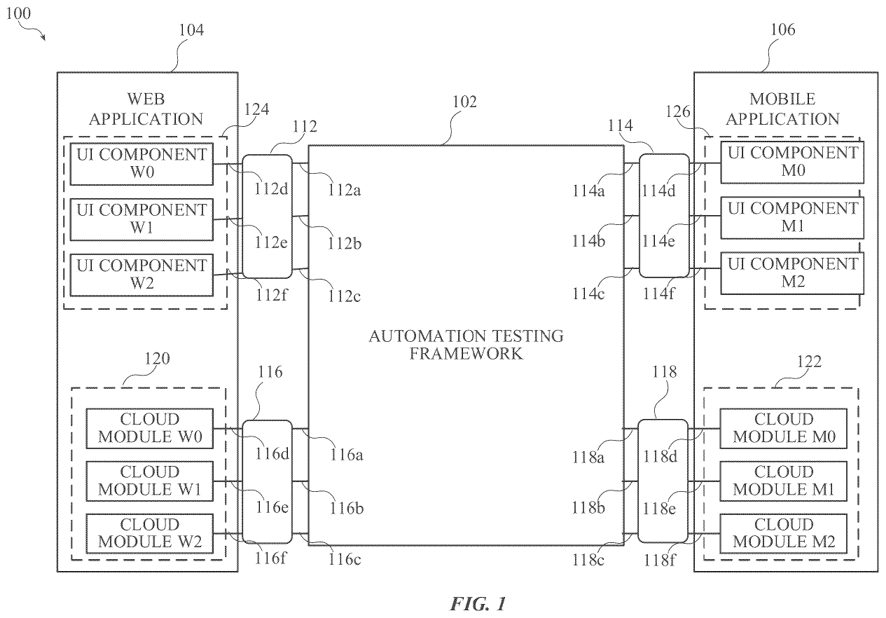

FIG. 1 illustrates an example software build system 100 comprising an automation testing framework 102 that operates to test a software build across various development units of developer teams and across various application types (e.g., web application(s), mobile application(s), and both web and mobile applications). Such testing includes testing functionality of development components or modules in API testing and UI testing in parallel, or at the same time, across various pipelines 112, 114, 116 and 118, in addition to various application types that include web applications and associated mobile applications, which can be a part of the same user story or epic projects.

API testing, or the testing of API modules, generally is performed utilizing a non-browser based automation framework suite, or toolchains that are non-browser based. API testing includes testing interactions between a client and remote service in a software application to ensure functionality of features in the application. The automation testing framework 102 can perform testing as non-browser based or browser based. Testing service functionality and on-site validation in applications of remote client devices can ensure the quality of a user experience and guarantees operable functionality of the application(s) before and after deployment. API testing, for example, simulates the context (e.g., libraries, compilation, and support programs) of an application that would be available when the application is executed on a mobile device, web service or other remote service over a client device (e.g., a user equipment, mobile phone, or computer device). The context can include code paths that can be subject to error when application developers address issues that arise before, as well as after, the product release, deployment or updates in the application (including a web application and a mobile application) within browsers of different platforms (e.g., Android OS, iOS, other operating systems, or versions of operating systems). Different browsers can function differently, so API testing alone may not uncover or test for issues associated with different browsers for applications in a same manner as UI testing. The automation testing framework 102 thus operates to test the API and the UI together for an efficient automation testing framework.

API testing or the testing of API modules, in particular, focuses on verifying the functionality and communication between software functional components or API modules (e.g., cloud modules or cloud-based modules) of the application(s) (web application, mobile application, or both) through API interactions, while UI testing focuses on the visual elements (components) and user interactions within a software application's UI, ensuring that buttons, menus, or other visual components work as intended and provide a good and working user experience; essentially, API testing checks the “backend” logic while UI testing checks the “frontend” presentation that user/client devices see and interact with by simulating those interactions for applications as part of a user story or epic.

In an aspect, the automation testing framework 102 integrates API testing of cloud modules 120 and 122 with UI testing of UI components 124 and 126 so they are unified in the same application in both a web application 104 and a mobile application 106 that can be associated or part of a same user story or epic as the web application 104. The API testing and the UI testing can be developed and executed at the same time in parallel by automating browser-based API testing alongside and with UI testing in order to ensure that execution of the application in production and in development, as well as after deployment on-site, produces the same results, functionalities and user experience.

Cloud modules 120 and 122 can represent functionalities within the API of an application (including both the web application 104 and the mobile application 106). API testing can include validation that the functions operate properly as well as their functional interactions among one another. For example, if a functionality (e.g., tagging or other function) of one cloud module (e.g., cloud module Wo) is supposed to be tagged upon making a particular match to trigger another function (cloud module W1) based on the tag, these interactions and communications between functionalities can be tested together with the UE components 124 and 126 as the modules and components are modified or updated. If the functionalities operate successfully, then the API testing of the API cloud module with this functionality from among API cloud modules 120 or 122 a successful status indication can be generated; if not successful, a flag or other indication of an unsuccessful API test can be indicated.

Cloud modules 120 can include cloud modules W0 thru W2 of the web application 104, for example, which can include more or less cloud modules. Similarly, cloud modules 122 can include cloud modules M0 thru M2 of the mobile application 106, for example, which can include more or less cloud modules. Cloud modules 120 are associated with the web application 104, while cloud modules 122 are associated with a mobile application 106. The web application 104 can be accessed and deployed through a browser (e.g., Chrome, Firefox, Safari, etc.), while the mobile application is installed and operated directly on a mobile device (e.g., a smartphone or tablet). No installation on a client device is necessary for the web application 104 to be executed; instead execution is performed on a web server and delivered to a browser of the user. In contrast, the mobile application 106 performs an installation to be executed on a mobile device of a user.

Cloud modules 120 of the web application 104 and cloud modules 122 of the mobile application 106 can be cloud-based functionalities used by remote servers connected to the internet to store, manage and process data according to various functionalities within their particular application. Each cloud module can be associated with a different functionality within the associated application. Cloud module W0 can provide similar or different functionality within the web application as cloud module M0, for example. Likewise, cloud modules W1 and W2 of cloud modules 120 in the web application 104 can correspond with or differ in functionality from cloud modules M1 and M2 of cloud modules 122 in the mobile application 106. Each of cloud modules 120 and 122 can be a set of processes, routines, or automated workflows that enable automation of storage provisioning, data protection or operations within their respective applications (web application 102 and mobile application 104) as part of the same epic or user story. The cloud modules 120 and 122 can be accessed over a network to a cloud server, for example.

The automation testing framework 102 can operate to add/subtract, configure, update and test cloud modules 120 and 122 via pipelines 116 and 118, respectively, alongside or in parallel to the UI components 124 of the web application 104 and the UI components 126 of the mobile application 106 via pipelines 112 and 114, respectively. In an aspect, the automation testing framework 102 is configured to perform comprehensive testing to automate both UI and API tests across modern technologies such as web and mobile applications, ensuring thorough validation of the product of the epic or user stories in different platforms or browsers.

For example, when interactions between functions are generated, modified or updated in the APIs, the UI testing can be performed at the same time as the API testing in a unified framework. Likewise, where UI features of UI components 124 and 126 become generated, modified or updated, the user interface components (e.g., buttons, menus, or other visual components for user interaction) can be tested along with any associated API functionalities of cloud modules 120, 122 within the context or parameters of the UI for various browsers; in this manner, the logic of the application on the API side gets tested for quality and functionality to any backend processes, while the user interactions in the UI are tested to replicate user workflows and verify front end behavior in parallel based on what functionalities are being generated, modified or updated in different browsers and platforms.

In an aspect, the automation testing framework 102 operates through various parallel pipelines 112 and 114 for particular sets of UI components 124,126 in parallel to operate along other pipelines 116 and 118 for sets of API cloud modules 120 and 122. Each of the UE components and cloud modules can be tested independently and in unison along the parallel pipelines 112, 114, 116, 118. Each parallel pipeline 112, 114, 116, 118 can comprise a chain of processing components that include processors, processes, threads, co-routines, functions, etc. The inputs 112a-c, 114a-c, 116a-c, 118a-c couple to outputs 112d-f, 114d-f, 116d-f, 118d-f between the automation testing framework and the cloud modules 120,122 and UI components 124,126, respectively, in one direction and be outputs from the cloud modules 120,122 and UI components 124,126 to the automation testing framework in another or opposite direction of flow. The automation testing framework 102 is thus configured to integrate seamlessly with the pipelines 112, 114, 116 and 118 as a continuous integration (CI)/continuous development (CD) pipelines to validate build quality of the applications 104 and 106 at various stages of the development lifecycle to enhance efficiency and reliability, including development testing of the API and UI with cloud modules (components) and UI components in the same or different phases of development, especially before and after product development and deployment to client devices for on-going and periodic on-site validation testing, modification, testing and update of the web application(s) 104 and mobile application(s) 106 by adding, subtracting, modifying or updating the modules or components thereof.

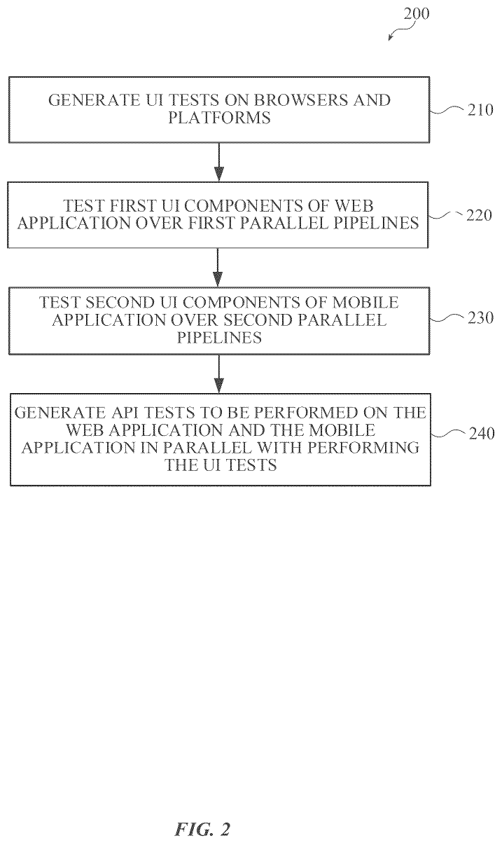

Referring to FIG. 2, illustrated is a method or process flow 200 for automation testing of an automation testing framework. The process flow 200 can be configured in a firmware build system with processes and tools to create, package and deploy the firmware code in a computer or mobile device for automation testing that confirms, validates, and reports whether firmware application functions operate correctly as intended in application(s) deployed to target client devices. The process flow 200 initiates at 210 by generating a plurality of user interface (UI) tests, via the automation testing framework 102, on different browsers and platforms concurrently or in parallel as a unified automation testing framework.

In an aspect, the automation testing framework 102 can configure testing of various modules or components for various platforms and various browsers together. For example, UI testing can be performed to enable functionality and validate functionality of the modules (e.g., 120, 122) and components (e.g., 124, 126) for functional operation on different browsers at once, including, but not limited to, Chrome, Firefox, Safari, Edge, Opera, H, etc., that enables application access and display on the world wide web or internet, including websites, images, videos and other files for interaction therewith. The automation testing framework 102 can be configured to perform browser testing via a cloud-based testing platform component that enables users to test the web application 104 and the mobile application 106 across multiple browsers for different devices. Additionally, various platforms can also be tested with the web application 104 and the mobile application 106. Various platforms can include various operating systems including Android, iOS, gaming platforms, mobile platforms, web platforms, robotic platforms, or other operating systems. The automation tests can be generated from a series of manual tests configured into automated tests associated with various modules or components of the web application 104 and the mobile application 106 via the automated testing framework.

At 220, the process flow 200 comprises testing a first set of UI components 124 of the web application 104 with the UI tests on different browsers and platforms in parallel via the first set of parallel pipelines 112. At 230, the process flow 200 further comprises testing a second set of UI components 126 of the mobile application 106 with UI tests in parallel via a second set of parallel pipelines 114. Testing of the first set of UE components 124 of the web application 104 and the second set of UE components 126 of the mobile application 106 is performed in parallel at the same time across different parallel pipelines 112a-f and 114a-f. For example, the UI components 124, including UI component W0, UI component W1, and UI component W2 of the web (W) application 124 and UI component M0, UI component M1, and UI component 2 of the mobile (M) application 126 can be tested individually, or together and in parallel over various pipelines input and outputs (112a thru f, 114a thru f) of pipelines at the same time for testing over various browsers and platforms concurrently.

At 240, the process flow 200 comprises generating API tests to be performed on the web application 104 and the mobile application 106 in parallel with performing UI tests. These automation tests can perform validation of performance and operation on the functionality of each of the components 124, 126 and modules 120, 122, on updates of the components and modules for interaction with a UI and backend functionality of the various browsers and platforms on different devices together.

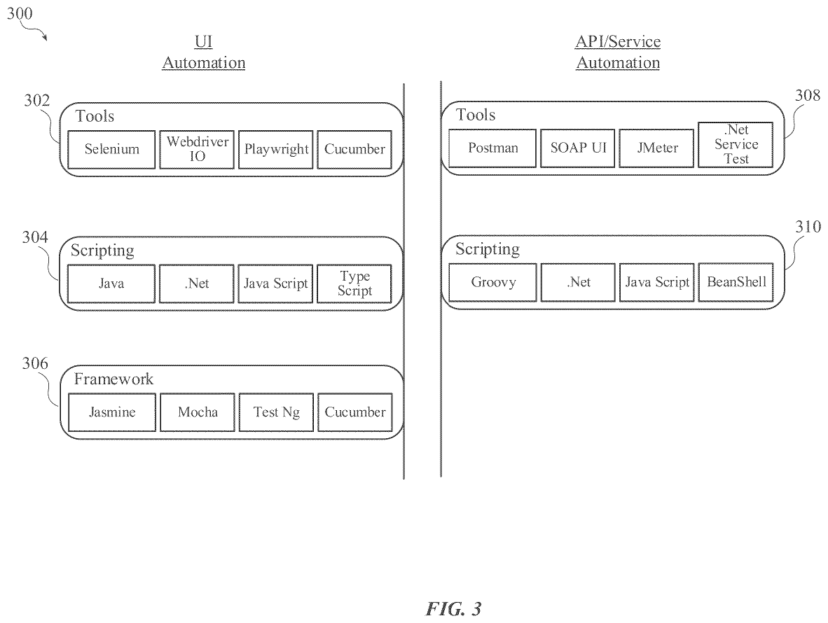

Referring to FIG. 3, illustrates an example of UI automation and API service automation for various software environments, which encompass tools, infrastructure and processes used to develop, test and deploy software or firmware that include operating systems, development tools, as well as databases and servers. The automation testing framework 102 can include tools 302, scripting 304, and framework products 306. For example, tools of UI automation can include a set of computer programs that developers use to create, maintain, debug or support other applications and programs, which can be used for system maintenance, as well as updating and testing components and modules before deployment and after deployment in on-site validations executed continuously and periodically at client devices.

In an example, tools 302 can include one or more of tools or products including Selenium, WebDriver IO, Playwright, Cucumber, or the like, for employing such tools as libraries, compilers, support programs for configuring manual tests and corresponding automation tests to match the manual tests in UI automation. Tools 308 for API/service automation can include Postman, SOAP UI, JMeter, .Net Service test, or other software tools, for example. In scripting 304, various programming languages that provide instructions for software and operating systems to perform particular functions associated with the UI and API of application(s) 104 and 106 can include, for example, Java, .Net, Java Script, Type Script, or other scripting languages for UI functions of associated UI components, for example. For the API functions, scripting 310 can include Groovy, .Net, Java Script, BeanShell, or other scripting for API functions of associated cloud modules. For example, the framework 306 can include different frameworks or framework resources for different applications such as Jasmine, Mocha, Test Ng, Cucumber or other framework resource.

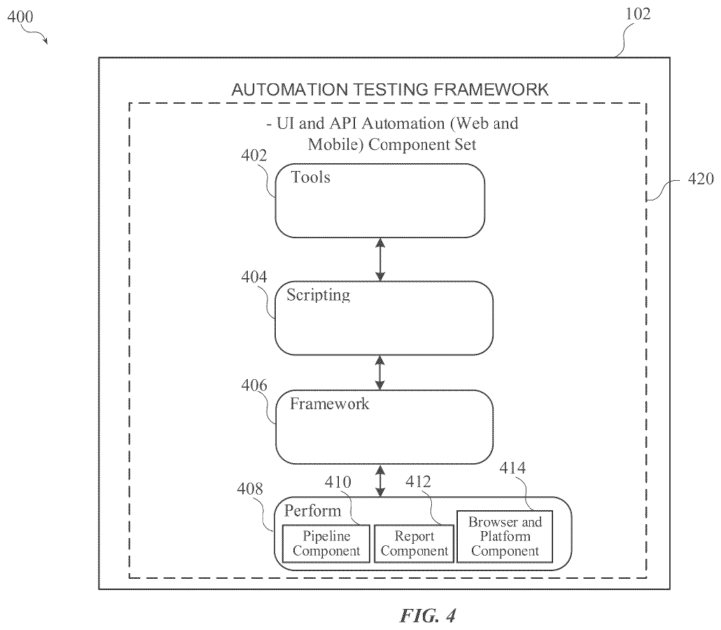

Referring to FIG. 4, illustrates is an example of the automation testing framework 102 that consolidates tools 402, scripting 404, framework 406 across various developer teams of user stories for selecting, building and testing in a process of a continuous integration (CI)/continuous development (CD) pipeline for an application of user stories of an epic.

In an aspect, the automation testing framework 102 can be configured to minimize reliance on multiple tools and technologies (including scripting and framework technologies or products), simplifying the testing process and reducing overhead. The automation testing framework 102 includes a set of software components 420 that can be used as tools for automation test builds, performing validation testing, maintenance, and updating of modules (e.g., cloud modules 120, 122) and components (e.g., UI components 124, 126). The set of software components 420 can be utilized as a software tool set to generate or process manual tests into automation tests, match manual tests of the modules and components, and configure perpetual and periodic on-site testing on client devices in real time for further update.

In an aspect, the automation testing framework 102 provides a consolidated set of tools and technologies for each team of developers working on a user story or epic to utilize in order to unify and make mainstream resources in a project build for applications. API testing and UI testing of the applications can be focused along teams with given resources in the automation testing framework 102 that can be selected from the consolidated set. These resources include resource tools such as tools 402, scripting 404, framework 406, and performance components 408 for implementing processes from manual tests into automation tests of the API and UI. In this manner, the automation test framework 102 can minimize transitioning from different application types and different languages to reduce reliance on multiple tools and technologies, and reduce any overall repeated efforts. The automation test framework 102 is configured to then operate to confirm code check-ins after a modification to validate whether these updates are functionally successful with the solution at the UI components and API modules in applications. In this manner, the automated testing framework 102 can contribute to software issues or improvements toward other teams also, and evolve the overall framework for an application over a period of time that can significantly reduce time, coverage and resources being expensed to any particular module or component function for the user story and the overall project epic.

Performance components 408 can include pipeline component 408, report component 412 and browser/pipeline component 414, which can be communicatively coupled to one another via one or more inputs and outputs (not shown). The pipeline component 408 can be configured to process a branch strategy with the various pipelines 112, 114, 116, and 118, for example. The pipeline component 408 is configured to execute automation tests by validating features and functions of the API cloud modules 120, 122 and UI components 124, 126 in parallel for both the web application 104 and corresponding mobile application 106. The pipeline component 408 operates as a component of the CI/CD to support and execute a same code format as that of the API cloud modules 120, 122 and UI components 124, 126, which can be selected or configured from among different code formats from the tools 402, scripting 404, or framework 404; the code format can include a shared code format that is shared and used from among the developer teams associated with the user stories or epic. The code format can include a programming language, a syntax, a spacing and indention, a naming convention, etc., for example, and can vary between the code format that is selected and configured for the API cloud modules 120, 122 and the UI components 124, 126, as well as between for the web application 104 and the mobile application 106, for example.

The pipeline component 410 can be configured to apply tests in a same code format as the API modules and UI components, which could be the same code format at the API cloud modules 120, 122, the UI components 124, 126 or both cloud modules 120, 122 and the UI components 124, 126 depending on the framework build. The pipeline component 410 can be an open-source automation server, for example, which streamlines development processes for automating tasks for building, testing, and deploying projects to client devices. The pipeline component 410 is configured to execute build tasks that can be triggered by branches, pull requests or commits to continuously build applications across various platforms. Once the application(s) are deployed, the pipeline component 410 can further generate code checks or code check-ins on updates and existing functions to be executed for on-site validation of the modules 120, 122 and components 124, 126 at the customer or client site to ensure consistency and reliability across different environments or platforms.

The report component 412 can generate a report comprising first results from the UI tests performed to the UI components 124 in the web application 102 through the parallel pipelines 112 and the UI tests performed to the UI components 126 in the mobile application 106 through the parallel pipelines 114. The report component 412 can further generate the report with results from the API testing done to validate or not the cloud modules 120 of web application 104 and cloud modules 122 of mobile application 106 via pipelines 116 and 118, respectively. The report component 412 is configured to identify and report what modules and components of the web application 104 and mobile application 106 function and integrate successfully within the application(s). The report component 412 is configured to assist in test planning, design, execution, and reporting to help improve quality of the application of a build system through efficient testing for both manual and automated tests. The report component 412 can check, delete and repeat test exposures remotely in a developer device for on-site validations of the application and its updates by identifying vulnerabilities in open source and compliance.

The browser and platform component 414 can operate together with the pipeline component 410 and report component 412 to execute testing of the API cloud modules 120, 122 and the UI components 124, 126 on different browsers together in time and on different platforms (e.g., Android, iOS, etc.). The browser and platform component 414 can operate as a testing manager component that matches manual tests from developer teams to automated tests, generates the automated tests based on the manual tests, and executes the automated tests as test cases on a periodic basis for on-site validation at client devices.

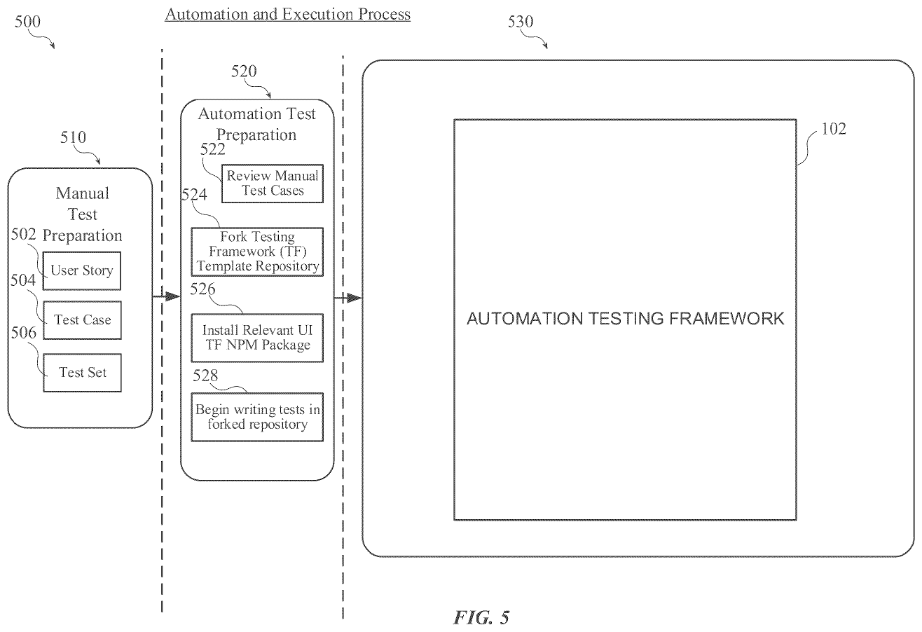

Referring to FIG. 5, illustrated is an example firmware build system process 500 illustrating an overall build process for various applications and their functions in associated modules (e.g., cloud modules 120, 122) and components (e.g., UI components 124, 126 of FIG. 1) for user stories. The system process 500 includes a manual test phase 510, an automation test preparation phase 520 and an automation execution phase 530 that includes the automation testing framework 102.

The system process 500 begins with a manual test preparation phase 510 that includes, for example, one or more user stories 512, test case(s) 504, and test set(s) 506 for different developer teams to contribute towards an overall epic. The user stories 512 include assignment or description of functions or features as a part of an epic to be built and operable from the perspective of the end user or a client device.

The user stories 502 can convey to a team of developers the user's expectation or functional demands as an objective within an epic or project system build, which can include a description of a feature or function in an application that is to be built. The test cases 504 can include a description of instructions that outline steps to take, input data to use, and expected outcomes to be verified with automation testing or validation, if a specific feature or functionality within the application is working as intended, acting as a plan structure to test a certain aspect of the application against defined requirements. The validation for the test cases 504 can be performed via API and UI testing in parallel to verify functionality of the features such as the API cloud modules 120, 122, and the UI components 124, 126, as well as assessing user experience, ease of interaction, and whether the modules/components interact with each other as expected or not. The test cases 504 can include guides for executing testing for validation of functionality and verifying the outcomes of the test cases as intended. The test sets 506 can include a grouping of test cases to evaluate a specific aspect or functionality of the application in order to ensure comprehensive testing of different scenarios and functionalities such as within a context of the application. The test sets 506 can include groupings of test cases 504 into sets making them easier to manage an execute testing (e.g., API and UI testing in parallel) as assigned to different teams for development, execution and validation testing of their successful function before deployment to client devices and after deployment for on-site validation to be performed periodically for updates and issue resolution.

The automation test preparation phase 520 can receive the outputs of the manual test preparation phase 510 and operate for developer teams to select, set up and configure resources for generating and executing automated tests on the application modules and components for determining successful operable status or not. These resources can include the tools 402, and the scripting 404 with the environment of framework 406 for creating test objectives, test scripts and executing the automated tests. Here, the automation test preparation phase 520 configures the testing environment to closely resemble the production environment, including software versions of the application(s) (e.g., web application 104 and mobile application 106), hardware and network configurations. The automation test preparation phase 520 can further integrate the automation tests into the CI/CD pipeline at the automation testing framework 102 to ensure that tests are run automatically with every code change, modification, or update at the automation execution phase 530.

The automation test preparation phase 520 includes processes that include reviewing manual tests 522. This can include developer team examinations of test cases, plans and scripts to ensure thoroughness, accuracy, and alignment with objectives and requirements of the API modules (e.g., modules 120, 122) and UI components (e.g., components 124, 126).

A fork testing framework (TF) template repository 524 can then be used to generate templates of the existing code and functional modules and components, including a separate copy or fork of the processes or code to independently develop and maintain one or more modified versions for such things as bug fixes, feature additions, addressing disagreements with the applications progression within the epic or user story. The fork TF template repository 524 can enable subtasks to be divided, executed in parallel and combined to obtain a single result within the product application and project development.

The automation test preparation phase 520 can further include a relevant UI TF node package manager (NPM) package 526 installation in order to provide a central repository of sharing script and projects among developer teams for automation testing. At 528, automation test preparation further includes initiating test writes in a forked repository.

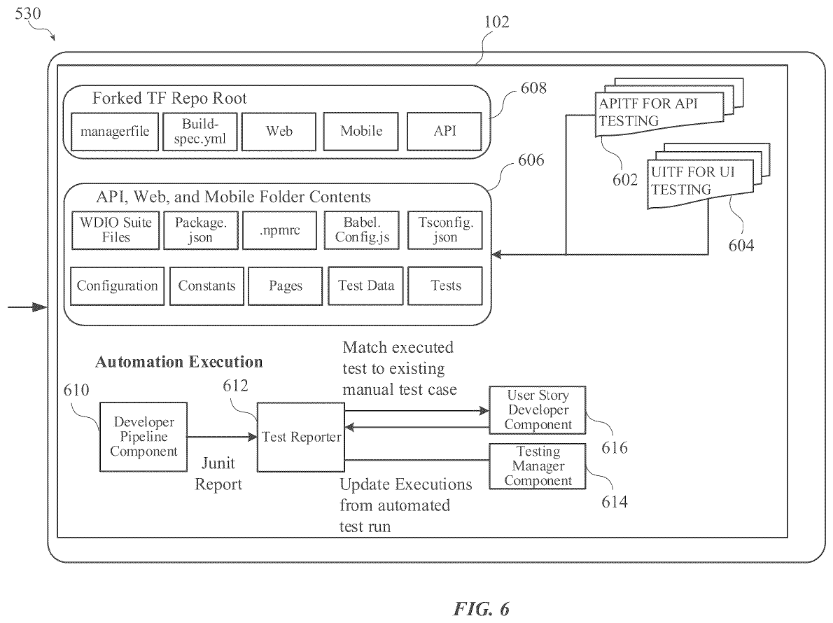

Referring to FIG. 6, illustrated is an example configuration of the automation execution phase 530 with the automation testing framework 102, which receives setup inputs, including an API TF for API testing 602 and UI TF for UI testing 604 from the automation test preparation phase 520 at processes or components 522 thru 528 to further configure automation tests for both the API testing and UI testing in parallel.

The inputs with any dependencies are entered into folder contents for the API, web application and mobile application folder contents 606, which can include suite files, packages, NMP files and registries, type script (TS), as well as configurations, constants, pages, test data and tests. These inputs along with folder contents 606 interface with the forked repository (repo) root 608, which enables flexible generation of API and UI testing in parallel with manager file contents, build specifications, code for web based applications, mobile applications, and their APIs. In this manner, the automation test framework 102 enables flexibility to bring all codes and technologies so that a developer or developer team can fork whatever tools are demanded without having to recall all other codes, tools or aspects. For example, if testing is to be performed for only mobile testing can be forked or copied for use, and if only the API or web, then those related tools can be utilized for generating the automating testing, In this manner, UI and API testing can be generated and performed in parallel. Tools therefore can be used based on relevant folders for corresponding project builds of the applications and application testing.

The testing developer pipeline component 610 is similar to the same as the pipeline component 410. The testing developer pipeline component 610 configures the overall framework, test cases and developing operations at a high level to write the test cases based on the user story and the manual cases using the framework tools, resources and technologies for functions developed as well as future versions or functions of UI components 124, 126 and API cloud modules 120, 122. The pipeline component 610 operates to enable the development and execution of UI and API tests using the same framework using the folder contents 606 and repository root 608 for multiple different teams working on different user stories of the epic. The testing developer pipeline component 610 can be a part of or comprise an open-source automation server, for example, which streamlines development processes for automating tasks for building, testing, and deploying projects to client devices based on the test cases. The testing developer pipeline component 610 can generate reports to the test reporter 612. For example, testing developer pipeline component 610 can provide a Junit report to the test reporter 612 for generating test results, which can be triggered for a periodic or daily basis by the component 610 and reporter 612.

The test reporter 612 is similar to, or the same as, the report component 412 that generates a report comprising first results from the UI tests performed to the UI components 124 in the web application 102 through the parallel pipelines 112 and the UI tests performed to the UI components 126 in the mobile application 106 through the parallel pipelines 114. The report component 412 can further generate the report with results from the API testing done to validate whether the cloud modules 120 of web application 104 and cloud modules 122 of mobile application 106 via pipelines 116 and 118, respectively, are operational according to expected function. The test reporter 612 is configured to identify and report in results what modules and components of the web application 104 and mobile application 106 function and integrate successfully within the application(s) for different browsers and platforms.

The test reporter 612 is configured to assist in test planning, designing, archiving execution, and reporting of testing to help improve quality of the application of a build system through continuous efficient testing for both manual and automated tests by providing results received from the testing manager component 610 to the user story developer component 614 and back to the test manager component 614. The test reporter 612 can check, delete and repeat test exposures remotely in a developer device for on-site validations of the application and its updates by publishing results to the testing manager component 614 and the user story component 616 identifying vulnerabilities in open source code and for compliance. The test reporter 612 is a component that can indicate whether functionalities are pass or fail, so that developers through the user story component 616 can operate to modify, add, subtract, or update functionalities as modules or components in the UI and API of application builds, such as a web application and a mobile application together in parallel.

The test manager component 614 receives published tests from the test reporter 612 and executes tests cases or case tests for the API modules and UI components based on code parameters or templates on a periodic basis. The tests can be executed on APIs and UIs of both the web application 104 and mobile application 106 in parallel, together on different browsers and different platforms at the same time. The test manager component 614 can include the browser and platform component 414 to execute testing of the API cloud modules 120, 122 and the UI components 124, 126 on different browsers together in time and on different platforms (e.g., Android, iOS, etc.) at the same time. The testing manager component 614 updates executions from automated test runs after the user story component 616 provides results back to the test reporter 612 by matching manual tests generated from developer teams to automated tests, generating the automated tests based on the manual tests, and executing the automated tests as test cases on a periodic basis for on-site validation at client devices.

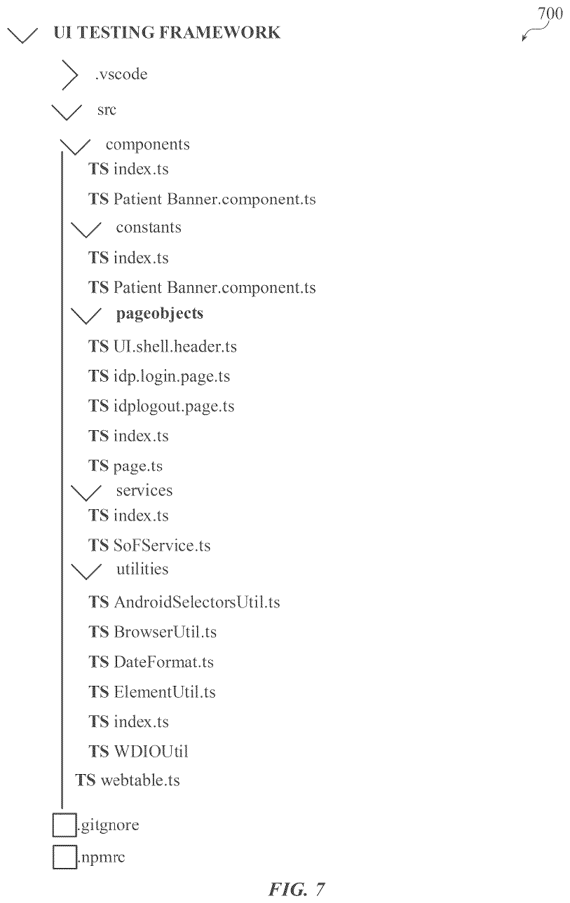

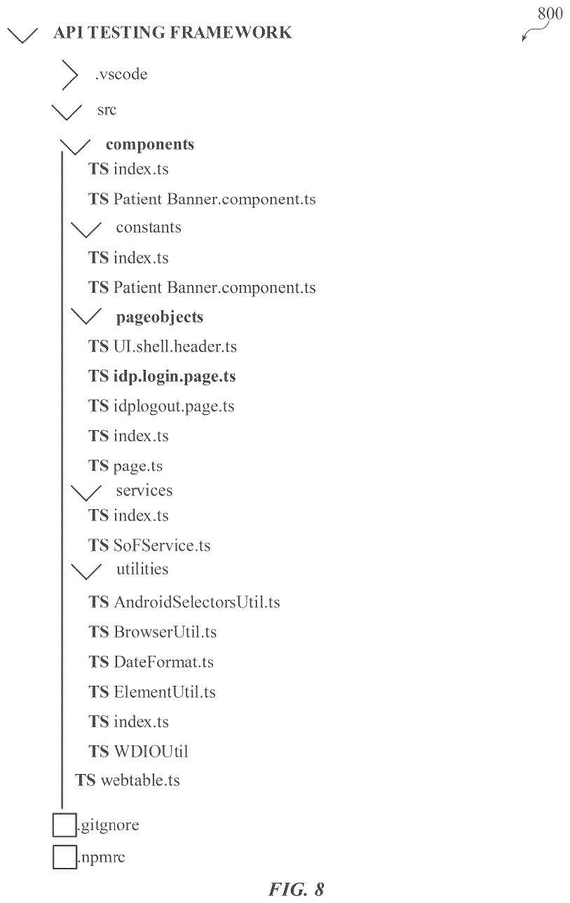

Referring to FIGS. 7 and 8, illustrated are examples of script for a UI testing framework 700 and an API testing framework 800, respectively, which can be utilized from the framework 102 across various developer teams and case tests from one repository or separately for one or more components or modules. The UI testing framework 700 can be configured as a page object model (POM) that represents web pages or components as objects, encapsulating their elements and interactions to improve code readability, maintainability, and reusability. The POM is based on an object repository (e.g., repo root 608 or other data storage) for storing pages of application(s) 104, 106.

The UI testing framework 700 and API testing framework 800 represent framework folder structures for the automation testing framework 102. Each page of an application can be captured and stored here. Testing can be performed at the test location, but upon testing, performance review or later released functionalities in modules or components, tools can be easily recalled at the browser, element, index, or other resources in the source code (or src) of the UI testing framework 700 and API testing framework 800 in order to not have to duplicate work product, repeat custom code, and save time and storage space, especially given that various functionalities, modules or components can be recalled instantly from these structures. Some functionalities can be considered constants, for example, which can be kept at the root level (e.g., repo root 608) to separate them from test case operation. Test cases can be executed using a programming interface through browsers (e.g., a WebDriver or other tool) that allows interaction with web browsers programmatically to automate interactions, perform testing and ensure functionality, where testing is being tracked or logged at a server or cloud for test writing there. In contrast, the API testing framework 800 of FIG. 8 does not utilize a page object model for the API text since no UIs are directly involved here.

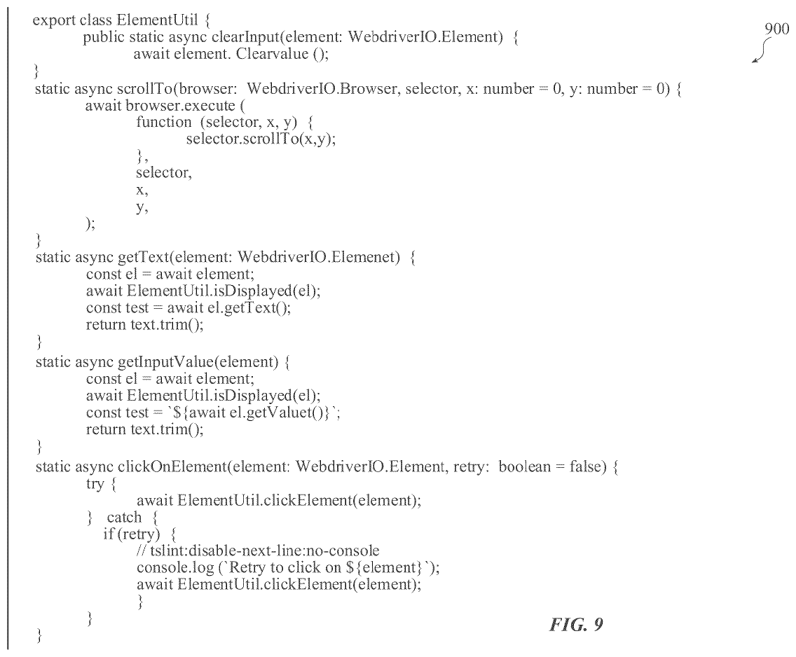

FIG. 9 illustrates an example code snippet 900 that demonstrates simple code for scrolling a mouse on a desktop. Here, the code 900 exemplifies different functionalities including for scrolling a mouse on a desktop, getting text, getting an input value, and clicking a button. Instead of writing the code every time an update, revision, version or modification of the application is developed and deployed, the code can be written as a function such as an “ElementUtil” type script as the element to be utilized in a UI component or other function for an API module. Anything related to the element such as validation, testing or repeated functionalities can import the element in a utility level and be utilized in the testing of a test case with only a single line of code. In this manner, all the functions can be brought into a framework level and recalled by other developers or test operations for validation of functionalities within the larger user story. In a similar manner, the automation testing framework 102 can utilize any element functions, browser functions or other activity as a set of consolidated or aggregated tools as part of the framework.

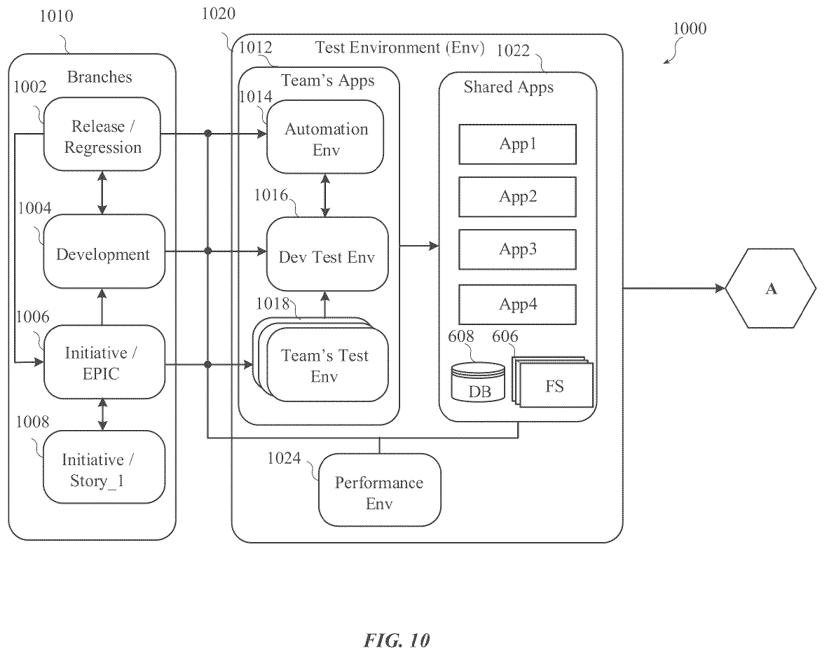

Referring to FIG. 10, illustrates an example CI/CD pipeline process 1000 as a part of and integrated in the pipeline of the automation testing framework 102. The first division can be comprised of branches 1010 that flows into the test environment processes of test environment 120. The branches 1010 includes processes that include release/regression 1002, in which a code release or update may become not functional or stop working as expected. This may be from unintended consequences of any changes to the web application 102, mobile application 104, or both that were released. The release/regression 1002 flows to development 1004 and to the initiative/epic (EPIC) 1006 for objectives and functional operation to be developed within initiative or parameters. Initiative/stories 1008 can be integrated and divided as part of the epic such as in user stories.

The branches 1010 provide inputs and access into the test environment 1020 of the automation testing framework 102 for generating various applications across multiple platforms and different browsers. The test environment 120 includes the developer team's applications (Apps) 1012 and shared applications 1022, which can be functional units of the web application 104 and mobile application 106. The team's applications 1012 include an automation environment 1014, a developer testing environment 1016, and a team's testing environment 1018 for developing manual testing of developer functions and automating them with the tools 402, scripting 404 and framework resources 406 together at the same time to be tested together in unison within the automation testing framework 102. Tools can include a consolidated tool set, including, for example, WebDriver IO or other tool for the UI testing, SuperTest or other tool for API testing, TypeScript or other tool for scripting, or Mocha or other tool for a framework resource, for example. The performance environment 1024 simulates and tests the various application components or modules by reporting results to the developer environments through the testing manager component 614 and the developer component 616 for updating of any unsuccessful functions occur and notification of successful functions.

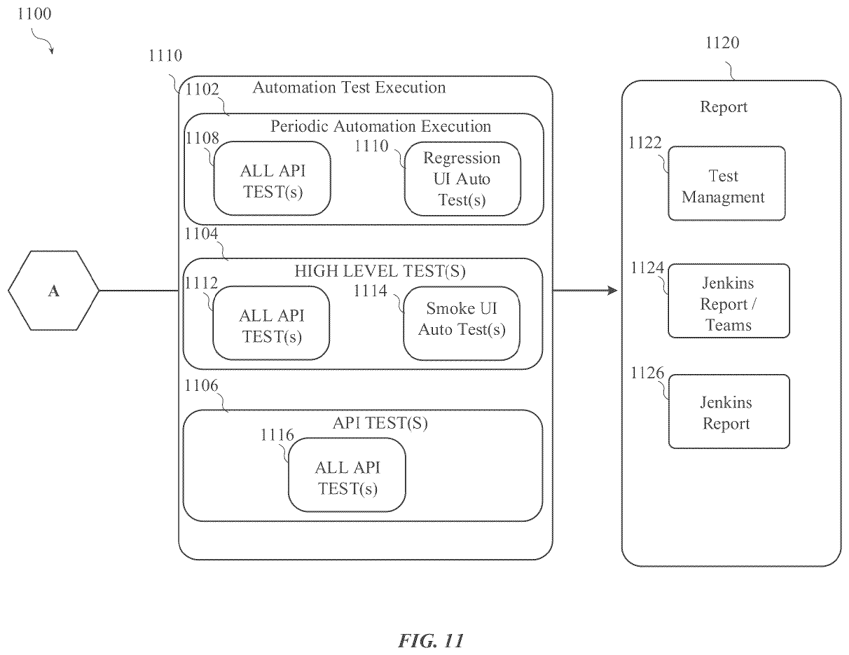

The CI/CD pipeline process continues at “A” of FIG. 11 further comprising automation test execution 1110 and reporting 1120. The API and UI tests can be quickly executed as part of the automation test execution 1110 of the automation testing framework 102 with periodic automation execution 1102 (e.g., nightly, daily, etc.) on a periodic basis, high level testing 1104 and API testing 1106. This process can indicate whether any functionality or interaction among modules and components is broken or are functionally successful at the reporting 1120 through the report of results (e.g., a Jenkins report or other report 1126 as part of the developer pipeline component 610. Reports of results or status of functionality can be published to both the developer component in the Jenkins report/teams 1124 and the test management 1122 to determine and execute further test executions based on the results.

The process 1000 and 1100 can be iterated as developers develop code for fixes or updated without having to wait for a tester. The tests can be performed on-site of client devices remotely via a server or cloud-based server. As developers back up code and continue to work on the applications (e.g., web application and mobile application) across various platform types (e.g., Android, iOS, other platforms, etc.) and browser types (e.g., Firefox, Chrome, etc.) developers can receive updates to continue on building the features or functionalities until the code is stable by quickly testing with the API test 1108, 1112 and 1116 with UI auto tests (e.g., regression UI auto test(s) 1110, smoke/high level UI auto test(s) 114). The API test 1108 can be periodic along with the regression UI auto test 1110, while the high level tests 1104 can be performed during development for quick feedback. The API test(s) 1112 can be completed along with the smoke UI tests 1114, these are quick can be completed within a short time frame (e.g., 20 or 30 minutes). This then produces the test report and that gives the go or no-go for the developers. Then finally the product is stable then they will release all the existing build and then every night we will deploying the code on the test environment, and running all API test 1108, 1116 and executing complete regression fully automation test in parallel on the various platforms and browsers together for publishing the test results to the test management component 1122 (e.g., an Xray tool) for execution.

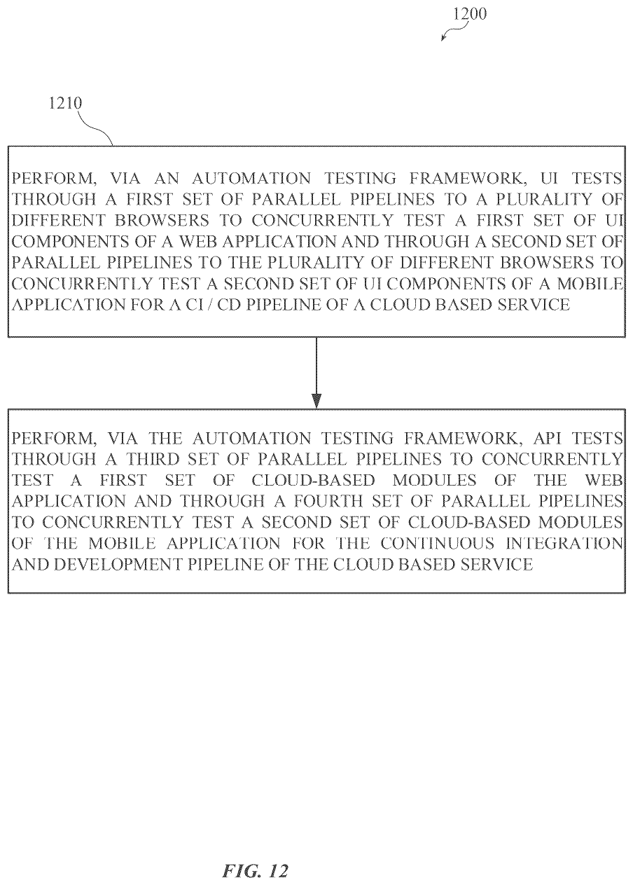

Referring to FIG. 12, illustrated is an example process flow 1200 for an automation testing framework. The process flow 1200 initiates at 1210 with perform, via an automation testing framework with memory and processing circuitry (e.g., one or more development processors), UI tests through a first set of parallel pipelines for different browsers to concurrently test a first set of UI components (e.g., 124, 126) of a web application 104 and through a second set of parallel pipelines to the different browsers to concurrently test a second set of UI components of a mobile application 106 for a continuous integration and development pipeline of a cloud based service.

At 1220, the process flow 1200 further comprises performing, via the automation testing framework, API tests through a third set of parallel pipelines to concurrently test a first set of cloud-based modules (e.g., cloud modules 120, 122) of the web application 104 and through a fourth set of parallel pipelines to concurrently test a second set of cloud-based modules of the mobile application 106 for the continuous integration and development pipeline (e.g., 1000, 1100) of the cloud based service.

In an aspect, the process flow 1200 can further include generating a report comprising first results from the UI tests to the first set of UI components in the web application through the first set of parallel pipelines and the UI tests to the second set of UI components in the mobile application through the first set of parallel pipelines from the second set of parallel pipelines. The report can further include a generation of the report with second results from the API tests to the first set of cloud-based modules of the web application through the third set of parallel pipelines and the plurality of API tests to the second set of cloud-based modules of the mobile application through the fourth set of parallel pipelines. The tests can be validation tests of functionality by performing the UI tests and the API tests on different mobile platforms in parallel to test the second set of UI components of the mobile application and the second set of cloud-based modules of the mobile application. Results of the tests can be provided to a test manager component. Then the functionality in the modules and components can be updated for executions of the automation testing framework based on the results.

The results of the UI tests and the API tests across different browsers and different platforms can be provided to both a testing manager component 614 and a testing developer component 616 that matches manual tests to automated tests of the UI tests and the API tests for the mobile application 106 and the web application 104.

In an aspect, the process flow 1200 can include performing on-site validation by performing periodic tests with the UI tests and the API tests, which can be updated and performed via the automation testing framework across browsers and platforms in the different applications.

In an aspect, a software tool set of software components can be provided to generate manual tests to be matched with the UI tests and the API tests via the automation testing framework for developers to update, modify, add or subtract functionalities of components and modules configured in the applications.

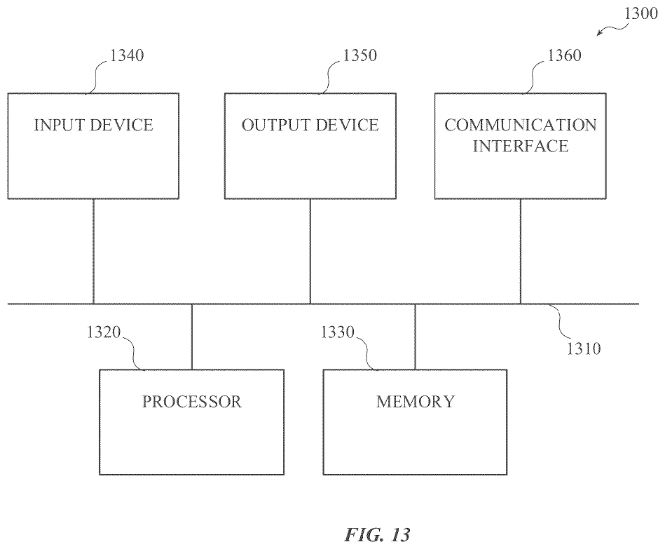

FIG. 13 is a diagram of example components of a device 1300 that can be used with/within environment or systems described in reference to FIG. 1 thru 12. Device 900 can correspond to a user equipment, client computer device, server, data repository 608, management component 614, reporter component 612, developer component 610, a computer readable medium device, or the like. Each of modules 120, 122, components 124, 126, automation test framework 102, data repository can include one or more of devices 900 and/or one or more of the components of device 900, for example, as with the components of other figures herein.

As depicted, device 900 can include bus 910 (e.g., pipelines 112 thru 118), processor 920, memory 930, input device 940, output device 950, and communication interface 960. However, the precise components of device 900 can vary between implementations. For example, depending on the implementation, device 900 can include fewer components, additional components, different components, or differently arranged components than those illustrated in FIG. 9.

Bus 910 can permit communication among the components of device 900. Processor 920 can include one or more processors, microprocessors, data processors, co-processors, network processors, application-specific integrated circuits (ASICs), controllers, programmable logic devices (PLDs), chipsets, field-programmable gate arrays (FPGAs), or other components that can interpret or execute instructions or data. Processor 920 can control the overall operation, or a portion thereof, of device 900, based on, for example, an operating system (not illustrated), and/or various applications. Processor 920 can access instructions from memory 930, from other components of device 900, or from a source external to device 900 (e.g., a network or another device).

Memory 930 can include memory and/or secondary storage. For example, memory 930 can include random access memory (RAM), dynamic RAM (DRAM), read-only memory (ROM), programmable ROM (PROM), flash memory, or some other type of memory. Memory 930 can include a hard disk (e.g., a magnetic disk, an optical disk, a magneto-optic disk, or a solid state disk) or some other type of computer-readable medium, along with a corresponding drive. A computer-readable medium can be defined as a non-transitory memory device. A memory device can include space within a single physical memory device or spread across multiple physical memory devices.

Input device 940 can include one or more components that permit a user to input information into device 900. For example, input device 940 can include a keypad, a button, a switch, a knob, fingerprint recognition logic, retinal scan logic, a web cam, voice recognition logic, a touchpad, an input port, a microphone, a display, or some other type of input component. Output device 950 can include one or more components that permit device 900 to output information to a user. For example, output device 950 can include a display, light-emitting diodes (LEDs), an output port, a speaker, or some other type of output component.

Communication interface 960 can include one or more components that permit device 900 to communicate with other devices or networks. For example, communication interface 960 can include some type of wireless or wired interface. Communication interface 960 can also include an antenna (or a set of antennas) that permit wireless communication, such as the transmission and reception of radio frequency (RF) signals.

As described herein, device 900 can perform certain operations in response to processor 920 executing software instructions contained in a computer-readable medium, such as memory 930. The software instructions can be read into memory 930 from another computer-readable medium or from another device via communication interface 960. The software instructions contained in memory 930 can cause processor 920 to perform one or more processes described herein. Alternatively, hardwired circuitry can be used in place of, or in combination with, software instructions to implement processes described herein. Thus, implementations described herein are not limited to any specific combination of hardware circuitry and software.

Examples herein can include subject matter such as a method, means for performing acts or blocks of the method, at least one machine-readable medium including executable instructions that, when performed by a machine (e.g., a processor) with memory, an application-specific integrated circuit (ASIC), a field programmable gate array (FPGA), or the like) cause the machine to perform acts of the method or of an apparatus or system for concurrent communication using multiple communication technologies according to implementations and examples described.

A first example is a non-transitory computer-readable storage device comprising: executable instructions that in response to execution, cause one or more processors to: perform, via an automation testing framework, a plurality of user interface (UI) tests through a first set of parallel pipelines to a plurality of different browsers to concurrently test a first set of UI components of a web application and through a second set of parallel pipelines to the plurality of different browsers to concurrently test a second set of UI components of a mobile application for a continuous integration and development pipeline of a cloud based service; and perform, via the automation testing framework, a plurality of application programming interface (API) tests through a third set of parallel pipelines to concurrently test a first set of cloud-based modules of the web application and through a fourth set of parallel pipelines to concurrently test a second set of cloud-based modules of the mobile application for the continuous integration and development pipeline of the cloud based service.

A second example can include the first example, wherein the executable instructions further cause the one or more processors to: generate a report comprising first results from the plurality of UI tests to the first set of UI components in the web application through the first set of parallel pipelines and the plurality of UI tests to the second set of UI components in the mobile application through the first set of parallel pipelines from the second set of parallel pipelines.

A third example can include the first or second example, wherein the executable instructions further cause the one or more processors to: generate the report further comprising second results from the plurality of API tests to the first set of cloud-based modules of the web application through the third set of parallel pipelines and the plurality of API tests to the second set of cloud-based modules of the mobile application through the fourth set of parallel pipelines.

A fourth example can include any one or more of the first through third examples, wherein the executable instructions further cause the one or more processors to: perform the plurality of UI tests and the plurality of API tests on different mobile platforms in parallel to test the second set of UI components of the mobile application and the second set of cloud-based modules of the mobile application.

A fifth example can include any one or more of the first through fourth examples, wherein the executable instructions further cause the one or more processors to: provide results of the plurality of UI tests and the plurality of API tests to a test manager component; and update executions of the automation testing framework based on the results.

A sixth example can include any one or more of the first through fifth examples, wherein the executable instructions further cause the one or more processors to: provide results of the plurality of UI tests and the plurality of API tests to both a testing manager component and a testing developer component that matches manual tests to automated tests of the plurality of UI tests and the plurality of API tests.

A seventh example can include any one or more of the first through sixth examples, wherein the executable instructions further cause the one or more processors to: perform on-site validation by performing periodic tests with the plurality of UI tests and the plurality of API tests via the automation testing framework; and provide results of the periodic tests to both a testing manager component and a testing developer component for updating the automation testing framework.

An eighth example can include any one or more of the first through seventh examples, wherein the executable instructions further cause the one or more processors to: provide a software tool set of software components to generate manual tests to be matched with the plurality of UI tests and the plurality of API tests via the automation testing framework.

A ninth example can be a system for automation testing in a healthcare enterprise comprising: one or more processors, wherein the one or more processors are configured to: generate a plurality of user interface (UI) tests through a first set of parallel pipelines, via an automation testing framework, on a plurality of different browsers to concurrently test a first set of UI components of a web application, and, through a second set of parallel pipelines to the plurality of different browsers to concurrently test a second set of UI components of a mobile application for a continuous integration and development pipeline, wherein testing of the first set of UI components of the web application and the second set of UI components of the mobile application is generated in parallel to one another; and generate a plurality of application programming interface (API) tests through a third set of parallel pipelines, via the automation testing framework, to concurrently test a first set of cloud-based modules of the web application, and through a fourth set of parallel pipelines to concurrently test a second set of cloud-based modules of the mobile application for the continuous integration and development pipeline, wherein testing of the first set of cloud-base modules of the web application and the second set of cloud-based modules of the mobile application is generated in parallel to the testing of the first set of UI components of the web application and the second set of UI components of the mobile application.

A tenth example can include the ninth example, wherein the one or more processors are further configured to generate a report comprising first results from the plurality of UI tests to the first set of UI components in the web application and the plurality of UI tests to the second set of UI components in the mobile application, the report further comprising second results from the plurality of API tests to the first set of cloud-based modules of the web application and the plurality of API tests to the second set of cloud-based modules of the mobile application.

An eleventh example can include any one or more of the ninth through tenth examples, wherein the one or more processors are further configured to: perform the plurality of UI tests and the plurality of API tests on different mobile platforms in parallel to test the second set of UI components of the mobile application and the second set of cloud-based modules of the mobile application.

A twelfth example can include any one or more of the ninth through eleventh examples, wherein the one or more processors are further configured to: provide results of the plurality of UI tests and the plurality of API tests to both a testing manager component and a testing developer component, wherein the testing developer component matches manual tests to automated tests of the plurality of UI tests and the plurality of API tests.

A thirteenth example can include any one or more of the ninth through twelfth examples, wherein the one or more processors are further configured to: provide a software tool set comprising software components to generate manual tests; and generate the plurality of UI tests and the plurality of API tests, via the automation testing framework, based on the manual tests and feedback from a periodic on-site testing of the first set of UI components of the web application, the second set of UI components of the mobile application, the first set of cloud-base modules of the web application and the second set of cloud-based modules of the mobile application.

A fourteenth example can include any one or more of the ninth through thirteenth examples, wherein the one or more processors are further configured to: perform on-site validation by performing periodic tests with the plurality of UI tests and the plurality of API tests via the automation testing framework; and provide results of the periodic tests to both a testing manager component and a testing developer component, wherein the testing developer component matches manual tests to automated tests of the plurality of UI tests and the plurality of API tests.

A fifteenth example can be a method for automation testing of a firmware build system comprising: generating a plurality of user interface (UI) tests, via an automation testing framework, on a plurality of different browsers and platforms concurrently; testing a first set of UI components of a web application with the plurality of UI tests on the plurality of different browsers in parallel via a first set of parallel pipelines; testing a second set of UI components of a mobile application with the plurality of UI tests in parallel via a second set of parallel pipelines, wherein testing of the first set of UI components of the web application and the second set of UI components of the mobile application is performed in parallel to one another; and generating a plurality of application programming interface (API) tests to be performed on the web application and the mobile application in parallel with performing the plurality of UI tests.

A sixteenth example can include the fifteenth example, further comprising: testing, via the automation testing framework, a first set of cloud-based modules of the web application through a third set of parallel pipelines; and testing, via the automation testing framework, a second set of cloud-based modules of the mobile application through a fourth set of parallel pipelines.

A seventeenth example can include any one or more of the fifteenth through sixteenth examples, further comprising: providing results of the plurality of UI tests and the plurality of API tests to both a testing manager component and a testing developer component, wherein the testing developer component matches manual tests to automated tests of the plurality of UI tests and the plurality of API tests.

An eighteenth example can include any one or more of the fifteenth through seventeenth examples, further comprising: generating the plurality of UI tests and the plurality of API tests, via the automation testing framework, based on manual tests generated from software components of a software tool set.

A nineteenth example can include any one or more of the fifteenth through eighteenth examples, further comprising: receiving feedback from a periodic on-site testing of the first set of UI components of the web application, the second set of UI components of the mobile application, a first set of cloud-base modules of the web application and a second set of cloud-based modules of the mobile application.

A twentieth example can include any one or more of the fifteenth through nineteenth examples, further comprising: providing results of the plurality of UI tests and the plurality of API tests to both a testing manager component and a testing developer component that is communicatively coupled to the testing manager component, wherein the testing developer component matches manual tests to automated tests of the plurality of UI tests and the plurality of API tests, and the testing manager component updates and executes the plurality of UI tests and the plurality of API tests based on updates received from the testing developer component.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature can have been disclosed with respect to only one of several implementations, such feature can be combined with one or more other features of the other implementations as can be desired and advantageous for any given application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context can indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled to minimize risks of unintentional or unauthorized access or use, and the nature of authorized use should be clearly indicated to users.

What is claimed is:

1. A non-transitory computer-readable storage device comprising:
executable instructions that in response to execution, cause one or more processors to:
perform, via an automation testing framework, a plurality of user interface (UI) tests through a first set of parallel pipelines to a plurality of different browsers to concurrently test a first set of UI components of a web application and through a second set of parallel pipelines to the plurality of different browsers to concurrently test a second set of UI components of a mobile application for a continuous integration and development pipeline of a cloud based service; and
perform, via the automation testing framework, a plurality of application programming interface (API) tests through a third set of parallel pipelines to concurrently test a first set of cloud-based modules of the web application and through a fourth set of parallel pipelines to concurrently test a second set of cloud-based modules of the mobile application for the continuous integration and development pipeline of the cloud based service.

2. The non-transitory computer-readable storage device of claim 1, wherein the executable instructions further cause the one or more processors to:
generate a report comprising first results from the plurality of UI tests to the first set of UI components in the web application through the first set of parallel pipelines and the plurality of UI tests to the second set of UI components in the mobile application through the first set of parallel pipelines from the second set of parallel pipelines.

3. The non-transitory computer-readable storage device of claim 2, wherein the executable instructions further cause the one or more processors to:
generate the report further comprising second results from the plurality of API tests to the first set of cloud-based modules of the web application through the third set of parallel pipelines and the plurality of API tests to the second set of cloud-based modules of the mobile application through the fourth set of parallel pipelines.

4. The non-transitory computer-readable storage device of claim 1, wherein the executable instructions further cause the one or more processors to:
perform the plurality of UI tests and the plurality of API tests on different mobile platforms in parallel to test the second set of UI components of the mobile application and the second set of cloud-based modules of the mobile application.

5. The non-transitory computer-readable storage device of claim 1, wherein the executable instructions further cause the one or more processors to:
provide results of the plurality of UI tests and the plurality of API tests to a test manager component; and
update executions of the automation testing framework based on the results.

6. The non-transitory computer-readable storage device of claim 1, wherein the executable instructions further cause the one or more processors to:
provide results of the plurality of UI tests and the plurality of API tests to both a testing manager component and a testing developer component that matches manual tests to automated tests of the plurality of UI tests and the plurality of API tests.

7. The non-transitory computer-readable storage device of claim 1, wherein the executable instructions further cause the one or more processors to:
perform on-site validation by performing periodic tests with the plurality of UI tests and the plurality of API tests via the automation testing framework; and
provide results of the periodic tests to both a testing manager component and a testing developer component for updating the automation testing framework.

8. The non-transitory computer-readable storage device of claim 1, wherein the executable instructions further cause the one or more processors to:
provide a software tool set of software components to generate manual tests to be matched with the plurality of UI tests and the plurality of API tests via the automation testing framework.

9. A system for automation testing in a healthcare enterprise comprising:
one or more processors, wherein the one or more processors are configured to:
generate a plurality of user interface (UI) tests through a first set of parallel pipelines, via an automation testing framework, on a plurality of different browsers to concurrently test a first set of UI components of a web application, and, through a second set of parallel pipelines to the plurality of different browsers to concurrently test a second set of UI components of a mobile application for a continuous integration and development pipeline, wherein testing of the first set of UI components of the web application and the second set of UI components of the mobile application is generated in parallel to one another; and
generate a plurality of application programming interface (API) tests through a third set of parallel pipelines, via the automation testing framework, to concurrently test a first set of cloud-based modules of the web application, and through a fourth set of parallel pipelines to concurrently test a second set of cloud-based modules of the mobile application for the continuous integration and development pipeline, wherein testing of the first set of cloud-base modules of the web application and the second set of cloud-based modules of the mobile application is generated in parallel to the testing of the first set of UI components of the web application and the second set of UI components of the mobile application.

10. The system of claim 9, wherein the one or more processors are further configured to:
generate a report comprising first results from the plurality of UI tests to the first set of UI components in the web application and the plurality of UI tests to the second set of UI components in the mobile application, the report further comprising second results from the plurality of API tests to the first set of cloud-based modules of the web application and the plurality of API tests to the second set of cloud-based modules of the mobile application.

11. The system of claim 9, wherein the one or more processors are further configured to:
perform the plurality of UI tests and the plurality of API tests on different mobile platforms in parallel to test the second set of UI components of the mobile application and the second set of cloud-based modules of the mobile application.

12. The system of claim 9, wherein the one or more processors are further configured to:
provide results of the plurality of UI tests and the plurality of API tests to both a testing manager component and a testing developer component, wherein the testing developer component matches manual tests to automated tests of the plurality of UI tests and the plurality of API tests.

13. The system of claim 9, wherein the one or more processors are further configured to:
provide a software tool set comprising software components to generate manual tests; and
generate the plurality of UI tests and the plurality of API tests, via the automation testing framework, based on the manual tests and feedback from a periodic on-site testing of the first set of UI components of the web application, the second set of UI components of the mobile application, the first set of cloud-base modules of the web application and the second set of cloud-based modules of the mobile application.

14. The system of claim 9, wherein the one or more processors are further configured to:
perform on-site validation by performing periodic tests with the plurality of UI tests and the plurality of API tests via the automation testing framework; and
provide results of the periodic tests to both a testing manager component and a testing developer component, wherein the testing developer component matches manual tests to automated tests of the plurality of UI tests and the plurality of API tests.

15. A method for automation testing of a firmware build system comprising:
generating a plurality of user interface (UI) tests, via an automation testing framework, on a plurality of different browsers and platforms concurrently;
testing a first set of UI components of a web application with the plurality of UI tests on the plurality of different browsers in parallel via a first set of parallel pipelines;
testing a second set of UI components of a mobile application with the plurality of UI tests in parallel via a second set of parallel pipelines, wherein testing of the first set of UI components of the web application and the second set of UI components of the mobile application is performed in parallel to one another; and
generating a plurality of application programming interface (API) tests to be performed on the web application and the mobile application in parallel with performing the plurality of UI tests.

16. The method of claim 15, further comprising:
testing, via the automation testing framework, a first set of cloud-based modules of the web application through a third set of parallel pipelines; and
testing, via the automation testing framework, a second set of cloud-based modules of the mobile application through a fourth set of parallel pipelines.

17. The method of claim 15, further comprising:
providing results of the plurality of UI tests and the plurality of API tests to both a testing manager component and a testing developer component, wherein the testing developer component matches manual tests to automated tests of the plurality of UI tests and the plurality of API tests.

18. The method of claim 15, further comprising:
generating the plurality of UI tests and the plurality of API tests, via the automation testing framework, based on manual tests generated from software components of a software tool set.

19. The method of claim 15, further comprising:
receiving feedback from a periodic on-site testing of the first set of UI components of the web application, the second set of UI components of the mobile application, a first set of cloud-base modules of the web application and a second set of cloud-based modules of the mobile application.

20. The method of claim 15, further comprising:
providing results of the plurality of UI tests and the plurality of API tests to both a testing manager component and a testing developer component that is communicatively coupled to the testing manager component, wherein the testing developer component matches manual tests to automated tests of the plurality of UI tests and the plurality of API tests, and the testing manager component updates and executes the plurality of UI tests and the plurality of API tests based on updates received from the testing developer component.
